(19) United States
(12) Patent Application Publication
(10) Pub. No.: US 2018/0240340 A1
(43) Pub. Date: Aug. 23, 2018

(54) Notification regarding an estimated movement path of a vehicle

(71) Applicant: GM GLOBAL TECHNOLOGY OPERATIONS LLC, Detroit, MI (US)

(72) Inventors: Marten Wittorf, Ingelheim (DE); Peter Kahler, Nierstein (DE)

(73) Assignee: GM GLOBAL TECHNOLOGY OPERATIONS LLC, Detroit, MI (US)

(21) Appl. No.: 15/901,977

(22) Filed: Feb. 22, 2018

(30) Foreign Application Priority Data
Feb. 22, 2017 (DE) 102017001707.7

(51) Int. Cl. G08G 1/123

(52) U.S. Cl. CPC G08G 1/123

(57) ABSTRACT

A system and method provide notification regarding an estimated movement path of a vehicle. A first vehicle includes an identification feature. A second vehicle includes an identification feature detection unit, an output unit and a transmission unit. A heuristic unit is configured to determine an estimation of an imminent movement path of the first vehicle. A position detection unit is configured to detect a current position of the first vehicle and/or the second vehicle and to transmit the detected current position to the heuristic unit. The identification feature detection unit is configured to detect and transmit the identification feature to the heuristic unit via the transmission unit. The heuristic unit is configured to transmit the current estimation for the first vehicle to the output unit via the transmission unit. The output unit is configured to communicate the estimation to a driver of the second vehicle.

### CROSS-REFERENCE TO RELATED APPLICATION

This application claims priority to German Patent Application No. 102017001707.7, filed Feb. 22, 2018, which is incorporated herein by reference in its entirety.

### TECHNICAL FIELD

The present disclosure pertains to a system and to a method for outputting an estimation of an imminent movement path of a first vehicle to a driver of a second vehicle.

### BACKGROUND

A challenge of the individual traffic is that a road user only has at his disposal a fraction of information regarding the intentions of another road user. For this purpose, motorized vehicles frequently have travelling direction indicators. Such travelling direction indicators however cannot adequately reflect the intentions of another road user in all situations.

### SUMMARY

The present disclosure provides a system and method to increase the road traffic safety and in particular facilitate assessing the current traffic situation. According to a first aspect of the present disclosure, a system includes a first vehicle with an identification feature, a second vehicle with an identification feature detection unit and a transmission unit, a heuristic unit configured to determine an estimation of an imminent movement path of the first vehicle, an output unit, and a position detection unit configured to detect a current position of the first vehicle and/or of the second vehicle and to transmit the detected current position to the heuristic unit. The identification feature detection unit is transmits the identification feature to the heuristic unit via the transmission unit and the heuristic unit is configured to transmit the current estimation for the first vehicle to the output unit via the transmission unit. Furthermore, the output unit is configured to output the estimation to a driver of the second vehicle.

The vehicle, in particular the first and the second vehicle, may be a car, commercial vehicle, bus, bicycle, stroller, electric scooter, agricultural machine, construction vehicle, rail vehicle, water craft (e.g., ship), submarine, or an aircraft. The system may be extended to other objects instead of the first vehicle, in particular a pedestrian, a robotic unit, an autonomous or network-controlled device (e.g., an active lane boundary or lane expansion). When the “vehicle” is extended to other objects instead of the first vehicle, these objects preferably have in common that they include an identification feature.

The heuristic unit is configured to determine a probabilistic estimation of a future movement path of the first vehicle. In the process, suitable probability theories and distributions are employed, which among other things can be supported by an artificial neural network. The artificial neural network, in particular, is trained by values in the past. This process can take place in the form of an off-line training. However, when current values support the estimation, the probabilistic estimation assumes traits of an on-line training. Furthermore, a Bayes' theorem or approach is applied. In other words, the heuristic unit is a processing unit which outputs an estimation for a future movement path of the first vehicle based on empirically accumulated information. The heuristic methods carried out on the heuristic unit advantageously determine a probable movement path of the first vehicle with low computational power. In particular, evolutionary and genetic algorithms are part of the heuristic methods. However, a multiplicity of methods from the major field of artificial intelligence and non-linear optimization may be generally applied.

The position detection unit together with the heuristic unit is preferably arranged in a central processing unit. Alternatively preferred or preferred in combination thereto, the position detection unit is a position detection unit of the first vehicle configured to transmit a currently detected position of the first vehicle to the central processing unit. The purpose of the position detection unit is that the heuristic unit has at its disposal a position information for at least the first vehicle (which under certain conditions is also approximately determinable from the position of the second vehicle), in order to determine the respective future imminent movement path of the first vehicle.

The identification feature of the first vehicle is a feature which uniquely identifies the first vehicle from a plurality of other vehicles. In particular, the identification feature detection unit may include a camera, lidar, radar.

The identification feature detection unit is configured to detect and also recognize exactly this identification feature. Thus, the identification feature detection unit constitutes a suitable means for detecting and for recognizing the identification feature.

In particular, the identification feature detection unit is configured to compare the detected identification feature in a data comparison with reference objects and/or reference situations in an expanded network when an allocation of the identification feature to the respective first vehicle by the identification feature detection unit and/or the heuristic unit has not yet taken place or is not possible. An advantageous effect of the present disclosure is that road traffic safety is improved and a current estimation of another road user is substantially facilitated for a driver of a vehicle.

According to an advantageous embodiment, the first vehicle further includes a vehicle locating unit configured to detect the position of the first vehicle and a transmission unit configured to transmit the detected position of the first vehicle to the heuristic unit.

The vehicle locating unit may include a satellite-based locating unit which improves the precision of a positioning of the vehicle utilizes additional sensor technology, which preferably includes one or more of the following elements: magnetic sensor, inertial measurement unit (“IMU”), satellite navigation system (e.g., NAVSTAR-GPS, GLONASS, Galileo, BeiDou, or IRNSS/NAVIC), camera for detecting an optical flow of a surroundings of the camera, a camera with image detection function for comparison with a digital map, or WLAN-locating unit for assigning a WLAN source to a position of the WLAN source. This sensor technology passes the respective data for the location of the vehicle on to a digital map. Data from different sensors are combined by data fusion to form an improved estimation of a determined vehicle position. This process preferably takes place with the help of a Kalman filter to filter jumps and noise up to a predefined bandwidth and introduce a certain inertia into the consolidated estimation of the current vehicle position. An analogous procedure or near-analogous procedure may be employed for determining a current orientation of the vehicle. The orientation of the vehicle is determined by an azimuth or yaw, or by the orientation of a longitudinal axis of the vehicle. Furthermore, an inclination or pitch angle of the vehicle and a roll angle of the vehicle can be determined. While an azimuth or yaw angle of the vehicle describes an angle of the longitudinal axis of the vehicle lying in a horizontal plane relative to north, the inclination or pitch angle indicates an inclination of the longitudinal axis of the vehicle relative to the horizontal plane. Accordingly, the roll angle of the vehicle describes an angle which materializes by the rolling of the vehicle about this longitudinal axis, respectively a projection of the longitudinal axis onto the horizontal plane compared with the horizontal plane. By way of all three angles, the yaw angle, the pitch angle and the roll angle of the vehicle (also called Euler angles), an orientation of the vehicle is completely described. Alternatively to Euler angles, reference to a quaternion description may be used should possible singularities during calculations in the coordinate transformation to another reference system occur. The transmission unit transmits the respective data preferably via a mobile radio network. The position detection unit is the vehicle locating unit of the first vehicle.

According to a further advantageous embodiment, the first vehicle further includes a navigation system with an active routing to a predetermined destination position and a transmission unit configured to transmit the routing to the heuristic unit. The prediction quality of the heuristic unit can thereby be increased.

According to a further advantageous embodiment, the identification feature includes at least one of the following elements: a shape of the first vehicle; a color scheme of the first vehicle; a movement pattern of the first vehicle; an optically readable characteristic mark; an electromagnetically readable characteristic mark; or an identification signal sent out from the first vehicle. The term “movement pattern” includes the intrinsic dynamism of a cyclist or of a driver of a personal transporter. The color scheme of the first vehicle relates to a pattern that is characteristic for the vehicle and preferably individual with respective colors. The electromagnetically readable characteristic mark may be an RFID chip.

In particular, the identification feature may include a color change of the first vehicle, a shaping of the first vehicle, a vehicle type of the first vehicle, characteristic changes in shaping of the first vehicle, a size of the first vehicle, a movement pattern of the first vehicle recognized in the past (in particular a direction or a speed of the first vehicle, or a movement path within the first vehicle), a light signal of the first vehicle (preferably a static/time-invariant light signal or a clocked/controlled light signal), a characteristic light reflection of the first vehicle, an acoustic signal of the first vehicle (in an audible and/or non-audible frequency range), a characteristic material of the first vehicle, or a combination of the identification features mentioned above.

According to a further advantageous embodiment, the identification signal is a light signal. This light signal is characterized in particular by a characteristic and unique radiation pattern over the course of time of the light signal. By way of this it is advantageously achieved that a signal which is not recognizable for the human eye is recognized by the identification feature detection unit.

According to a further advantageous embodiment, the heuristic unit is arranged in a central processing unit, for example a server. The heuristic unit is configured to support the estimation by at least one of the following elements: a statistical evaluation of the routes travelled by the first vehicle in the past; a current routing of a navigation system of the first vehicle; or a calendar entry in an electronic device of a driver of the first vehicle.

According to a further advantageous embodiment, the output unit is a head-up display of the second vehicle. The output unit may be a monitor of the second vehicle.

According to a further advantageous embodiment, the output unit is an electroacoustic transducer of the second vehicle. Preferably, the electroacoustic transducer of the second vehicle is a loudspeaker of the second vehicle.

According to a further advantageous embodiment, the output unit is a car-to-X communication device of the first vehicle. This car-to-X communication device may be an electroacoustic car-to-X communication device such as a horn or a device configured to transmit a light signal to the second vehicle in order to alert the driver of the second vehicle to a danger.

According to a further advantageous embodiment, the output unit is a control unit of the first vehicle, and the second vehicle includes an autopilot. The control device is configured to transmit a control signal to the autopilot of the second vehicle. Advantageously, driving parameters, a route guidance or other sub-systems of the autopilot of the second vehicle are thus influenced.

According to a further advantageous embodiment, the transmission unit is configured to transmit the respective data to be transmitted in an encrypted and/or anonymous manner.

In particular anonymization can be achieved by way of IP cascades of anonymization network for example “TOR”, as a result of which the source of the identification feature, i.e. the respective sender (first vehicle) is impossible to detect for a receiver. Furthermore, an encryption of the data serves to prevent an attacker from gaining access to personal data of the respective sender, i.e. of the first vehicle. In particular, data protection is advantageously supported in this embodiment.

A further aspect of the present disclosure relates to a method for outputting an estimation of an imminent movement path of a first vehicle with an identification feature to a driver of a second vehicle. In a first step, a current position of the first vehicle and/or of the second vehicle is detected and the detected current position is transmitted to a heuristic unit by a position detection unit. The identification feature is detected by an identification feature detection unit of the second vehicle. The identification feature is transmitted to the heuristic unit by a transmission unit of the second vehicle. An imminent movement path of the first vehicle is estimated and the current estimation is transmitted to an output unit of the second vehicle by the transmission unit. Finally, the current estimation is output to a driver of the second vehicle by the output unit.

Advantages and preferred further developments of the proposed method are obtained by an analogous and corresponding of the explanations made above in connection with the proposed device.

### BRIEF DESCRIPTION OF THE DRAWINGS

The present disclosure will hereinafter be described in conjunction with the following drawing figures, wherein like numerals denote like elements.

FIG. 1 shows a system for outputting an estimation of an imminent movement path of a first vehicle according to an exemplary embodiment of the present disclosure;

FIG. 2 shows a traffic situation, in which a system for outputting an estimation of an imminent movement path of a first vehicle according to a further exemplary embodiment of the present disclosure is employed; and

FIG. 3 shows a method for outputting an estimation of an imminent movement path of a first vehicle according to a further exemplary embodiment of the present disclosure.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

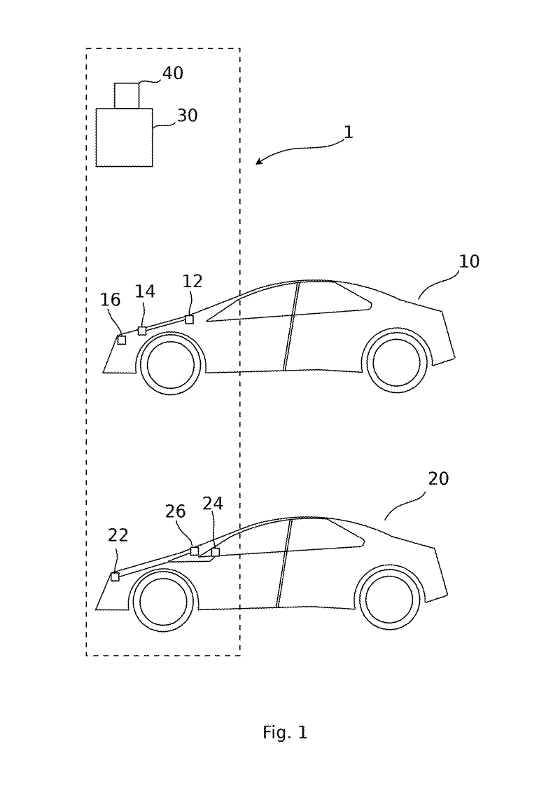

FIG. 1 shows a system 1 for outputting an estimation of an imminent movement path of a first vehicle 10. The system 1 includes a first vehicle 10 with an identification feature and a second vehicle 20 with an identification feature detection unit 22 with an output unit 24, and with a transmission unit 26. A heuristic unit 30 is configured to determine an estimation of an imminent movement path of the first vehicle 10. A position detection unit 40 is configured to detect a current position of the first vehicle 10 and/or of the second vehicle 20 and to transmit the detected current position to the heuristic unit 30.

The identification feature is a light signal emitted by a lighting system of the first vehicle 10 with a unique pattern of a sequence of the states of the lighting system “light on” and “light off” contained therein. The heuristic unit 30 is a system on a central server, and the position detection unit 40 is an analysis module which determines the position (e.g., by radio cell tracking) from which the second vehicle 20 sends an enquiry to the central server 30 via the transmission unit 26. This enquiry includes at least the question as to which currently imminent movement path the first vehicle 10 will probably take. The identification detection unit 22 to this end detects the abovementioned identification feature and transmits the same to the heuristic unit 30 via the transmission unit 26. The heuristic unit 30 determines an estimation of the imminent movement path of the first vehicle 1 from destination data of the first vehicle 10. Thus, the heuristic unit 30 is provided with clues as to the possible destination of the driver of the first vehicle 10. The destination data may be extracted from calendar data of a Smartphone of the driver of the first vehicle 10. The destination data may be extracted from a navigation system the imminent movement path of a hypothetical routing calculated by the heuristic unit 30 itself. Following this, the heuristic unit 30 transmits the current estimation of the imminent movement path of the first vehicle 10 to the output unit 24 of the second vehicle 20 via the transmission unit 26. The output unit 24 of the second vehicle 20 may be a monitor or display of the second vehicle 20. On this output unit 24, the estimation of the heuristic unit 30 is displayed for a driver of the second vehicle 20.

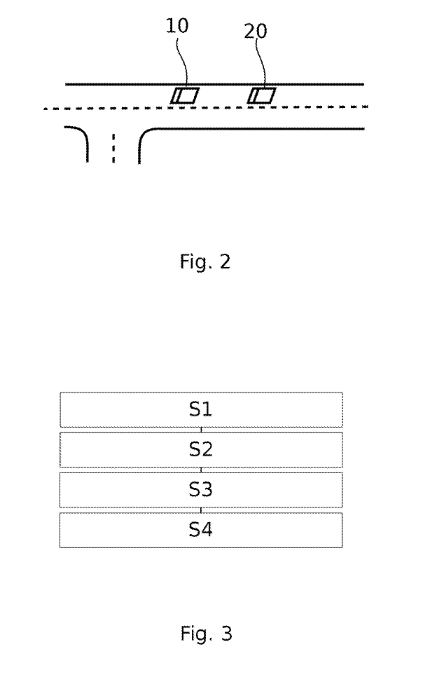

FIG. 2 shows a typical traffic situation in which the second vehicle 20 travels behind the first vehicle 10 on a road. To the driver of the rear second vehicle 20 it can be of decisive importance to correctly assess the imminent movement path of the first vehicle 10. For example, if the first vehicle 10 will travel straight ahead or turn to the left at the shown intersection. This is where the system 1 is applied. The system 1 in turn includes the first vehicle 10 with an identification feature, the second vehicle 20 with an identification feature detection unit 22, an output unit 24, a transmission unit 26, and a heuristic unit 30 which is configured to determine an estimation of the imminent movement path of the first vehicle 10. Furthermore, the system 1 includes a position detection unit 40 that serves to detect a current position of the first vehicle 10 and/or of the second vehicle 20 and to transmit the detected current position to the heuristic unit 30. An identification feature is a vehicle characteristic mark of the first vehicle 10. The heuristic unit 30 is a system on a central server. The position detection unit 40 is a vehicle locating unit 12 for detecting the position of the first vehicle 10. The detected position is transmitted to the heuristic unit 30 via a transmission unit 14 of the first vehicle 10. The identification feature detection unit 22 of the second vehicle 20 to this end includes a vehicle characteristic mark (e.g., number plate) of the first vehicle 10 and transmits the same to the heuristic unit 30 via the transmission unit 26. The heuristic unit 30 may be aware of a planned movement path of the first vehicle 10 from a navigation system 16 of the first vehicle 10 by way of active routing to a predetermined destination position. This routing is transmitted to the heuristic unit 30 via a transmission unit 14. Following this, the heuristic unit 30 transmits the current estimation of the imminent path of the first vehicle 10 to the output unit 24 of the second vehicle via the transmission unit 26. The output unit 24 of the second vehicle 20 may be a head-up display of the second vehicle 20. On the output unit 24, the estimation of the heuristic unit 30 is displayed to a driver of the second vehicle 20.

FIG. 3 shows a method for outputting an estimation of an imminent movement path of a first vehicle 10 with an identification feature to a driver of a second vehicle 20. A current position of the first vehicle 10 and/or of the second vehicle 20 is detected, and the detected current position is transmitted to a heuristic unit 30 by a position detection unit 40 at block S1. The identification feature is detected by an identification feature detection unit 22 of the second vehicle 20 and the identification feature is transmitted to the heuristic unit 30 by a transmission unit 26 of the second vehicle 20 at block S2. An imminent movement path of the first vehicle 10 is estimated and the current estimation is transmitted to an output unit 24 of the second vehicle 20 via the transmission 26 of the second vehicle 20 at block S3. The current estimation is communicated to a driver of the second vehicle 20 by the output unit 24 at block S4.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment as contemplated herein. It should be understood that various changes may be made in the function and arrangement of elements described in an exemplary embodiment without departing from the scope of the invention as set forth in the appended claims.

1-14. (canceled)

15. A system comprising:
a first vehicle having an identification feature;
a heuristic unit configured to estimate an imminent movement path of the first vehicle path;
a position detection unit configured to detect a current first vehicle position of the first vehicle and to transmit the current first vehicle position to the heuristic unit;
a second vehicle including an identification feature detection unit for detecting the identification feature of the first vehicle, a transmission unit and an output unit, wherein the identification feature detection unit is configured to detect and transmit the identification feature to the heuristic unit by the transmission unit;
wherein the heuristic unit is configured to transmit the current estimation for the first vehicle to the transmission unit which is in communication with the output unit for communicating the current estimation to a driver of the second vehicle.

16. The system according to claim 15, wherein the position detection unit is configured to detect a current second vehicle position of the second vehicle and to transmit the current second vehicle position to the heuristic unit.

17. The system according to claim 15, wherein the first vehicle further comprises:
a vehicle locating unit configured to identify a first vehicle location; and
a second transmission unit configured to transmit the first vehicle location to the position detection unit.

18. The system according to claim 16, wherein the first vehicle further comprises:
a navigation system with an active routing to a predetermined destination position; and
a second transmission unit configured to transmit the active routing to the heuristic unit.

19. The system according to claim 15, wherein the identification feature comprises at least one of the following elements:
a shape of the first vehicle;
a color scheme of the first vehicle;
a movement pattern of the first vehicle;
an optically readable characteristic mark;
an electromagnetically readable characteristic mark; and
an identification signal emitted by the first vehicle.

20. The system according to claim 19, wherein the identification signal comprises a light signal.

21. The system according to claim 15, wherein the heuristic unit comprises a central processing unit.

22. The system according to claim 21, wherein the heuristic unit is configured to estimate the imminent movement path of the first vehicle path by a statistical evaluation of the routes travelled by the first vehicle in the past.

23. The system according to claim 21, wherein the heuristic unit is configured to estimate the imminent movement path of the first vehicle path by a current routing of a navigation system of the first vehicle.

24. The system according to claim 21, wherein the heuristic unit is configured to estimate the imminent movement path of the first vehicle path by a calendar entry in an electronic device of a driver of the first vehicle.

25. The system according to claim 15, wherein the output unit comprises a head-up display of the second vehicle.

26. The system according to claim 15, wherein the output unit comprises a display of the second vehicle.

27. The system according to claim 15, wherein the output unit comprises an electroacoustic transducer of the second vehicle.

28. The system according to claim 15, further comprises a car-to-X communication device of the first vehicle.

29. The system according to claim 15, further comprising a control unit of the first vehicle and an autopilot of the second vehicle, wherein the control unit is configured to transmit a control signal to the autopilot of the second vehicle.

30. The system according to claim 15, wherein the transmission unit is configured to provide encrypted transmissions.

31. The system according to claim 15, wherein the transmission unit is configured to provide transmissions in an anonymous manner.

32. A method for outputting an estimation of an imminent movement path of a first vehicle to an output unit of a second vehicle comprising:
detecting a current position of at least one of the first vehicle and the second vehicle;
transmitting the current position to a heuristic unit;
detecting an identification feature of the first vehicle;
transmitting the identification feature to the heuristic unit;
estimating a current estimation of the imminent movement path of the first vehicle with the heuristic unit;
transmitting the current estimation to the output unit of the second vehicle; and
displaying the current estimation on the output unit.
